(19) United States
(12) Patent Application Publication
(10) Pub. No.: US 2026/0327738 A1
(43) Pub. Date: Oct. 22, 2026

(54) PROCESS FOR EXTRACTION OF RARE EARTH ELEMENTS

(71) Applicant: CENTRAL AMERICA NICKEL INC., Montréal (CA)

(72) Inventors: Pierre GAUTHIER, Montréal (CA); Mathieu BOUDREAU, Saint-Lambert-de-Lauzon (CA)

(21) Appl. No.: 19/485,306

(22) PCT Filed: May 17, 2024
(86) PCT No.: PCT/CA2024/050668

§ 371 Date: Nov. 18, 2025

Related U.S. Application Data
(60) Provisional application No. 63/502,986, filed on May 18, 2023.

(51) Int. Cl. C22B 3/06; C22B 1/02; C22B 1/248; C22B 3/12; C22B 7/00; C22B 59/00

(52) U.S. Cl. CPC C22B 3/065; C22B 1/02; C22B 1/248; C22B 3/12; C22B 7/007; C22B 7/008; C22B 59/00

(57) ABSTRACT

A process for the extraction and recovery of rare earth elements is described herein. More specifically, the process comprises leaching the rare earth element-containing material in a caustic solution while sonicating the caustic solution, thereby producing a caustic pregnant solution and a first residue comprising rare earth hydroxides; leaching the residue comprising rare earth hydroxides in a nitric acid solution while sonicating the nitric acid solution, thereby producing an acidic pregnant solution comprising rare earth nitrates and a second residue; roasting the rare earth nitrates at a temperature ranging from about 280° C. to about 375° C. thereby producing a first roasted residue comprising at least one of rare earth oxides, rare earth oxynitrates and rare earth nitrates; and roasting a residue substantially comprising the rare earth nitrates at a temperature ranging from about 200° C. to about 250° C. thereby producing a second roasted residue.

### CROSS REFERENCE TO RELATED APPLICATIONS

This application claims the benefit of U.S. Provisional Application 63/502,986, filed May 18, 2023. The contents of the referenced application are incorporated into the present application by reference.

### BACKGROUND

### 1. Field

This disclosure relates to the field of chemistry. More specifically, but not exclusively, the present disclosure broadly relates to a process for the extraction and recovery of rare earth elements. Yet more specifically, the present disclosure relates to a process for the extraction of the rare earth elements using one or more leaching steps, the separation of the rare earth elements into a heavy and a light REE fraction by selective roasting, and recovery of the rare earth elements. Yet more specifically, the present disclosure relates to a process for the extraction of the rare earth elements using one or more ultrasound assisted leaching steps, the separation of the rare earth elements into a heavy and a light REE fraction by selective roasting, and recovery of the rare earth elements.

### 2. Related Art

The following discussion of the background art is only intended to facilitate an understanding of the process described herein.

Rare earth elements (REEs) are essential components of current and emerging 21^{st} century technologies. Recent concern about future supplies of all the REEs now has narrowed chiefly to the heavy rare earth elements (HREEs). Essentially, all of the world's HREEs are currently sourced from the south China ion-adsorption clay deposits. The ability of those deposits to maintain and increase production is uncertain, particularly in light of environmental degradation associated with some mining and extraction operations in the region.

Rare earth elements (REEs) comprise seventeen elements in the periodic table, specifically the 15 lanthanide elements in addition to scandium and yttrium. The lanthanide series of chemical elements comprises the chemical elements with atomic numbers 57 through 71, from lanthanum through lutetium. REEs are a group of metallic elements with unique chemical, catalytic, magnetic, metallurgical and phosphorescent properties, and as such find use in a wide variety of modern devices including high-strength magnets, batteries, displays, lighting, and high performance metal alloys. Moreover, rare earth elements are profoundly valuable and are critical in the manufacture of electronics (e.g., microchips, semiconductors, in essence any product with a computer chip). China presently occupies a dominant position in the REE market; approximately 90% of REE purification being performed in China.

REEs are relatively plentiful in the earth's crust. However, REEs are typically highly dispersed and are not often found as concentrated rare earth minerals in economically exploitable ore deposits. There are plenty of REE deposits around the globe, particularly at asteroid impact sites such as in Vichada, Columbia. The REEs can be found in monazite sand deposits near the surface or in the more deeply encrusted ore deposits. Monazite is a primarily reddish brown phosphate mineral [(Ce,La, Nd,Th)PO₄], the major commercial source of Ce. Monazites occur as small heavy crystals in granitic and gneissic rocks and their detritus (called monazite sands). Monazite may contain up to 27 wt. % of U and Th oxides. Depending on the relative amounts of the rare earth elements in the mineral, there are several common species of monazite, the five main ones being: monazite-(Ce), (Ce,La,Nd,Th)PO₄ (the most common member); monazite-(La), (La,Ce,Nd)PO₄; monazite-(Nd), (Nd,La,Ce)PO₄; monazite-(Sm), (Sm,Gd,Ce,Th)PO₄; and monazite-(Pr), (Pr,Ce,Nd,Th)PO₄.

REEs may be further categorized based upon their value and/or their molecular weight. The critical rare earth elements (“CREEs”) include neodymium (Nd), europium (Eu), terbium (Tb), dysprosium (Dy), praseodymium (Pr) and yttrium (Y). The heavy rare earth elements (“HREEs”) include samarium (Sm), europium (Eu), gadolinium (Gd) terbium (Tb), dysprosium (Dy), holmium (Ho), erbium (Er), thulium (Tm), ytterbium (Y) and lutetium (Lu). The light rare earth elements (“LREE”) refer to lanthanum (La), cerium (Ce), praseodymium (Pr) and neodymium (Nd).

The lighter rare earth elements such as lanthanum, cerium, praseodymium, and neodymium are more abundant and concentrated and usually make up about 80%-99% of a total ore deposit. The heavier elements (Gd—Lu), which are on average 8-125 times more expensive than the light rare earth metals (lanthanides), are less abundant but higher in demand.

The extraction of REEs from mineral deposits is also challenging because mineral deposits containing REEs typically also contain appreciable levels of radioactive elements such as thorium (Th) and uranium (U) that must be safely and economically separated from the REEs during processing of the ore. Moreover, the separation of the rare earth elements (metals) from the ore materials constitutes a significant environmental problem. One of the major problems with conventional REE extraction is its extreme toxicity to both the environment and humans. Only a few countries (e.g., China) have approved the construction of conventional REE extraction plants.

Historically separation of rare earth metals can be divided into four main groups such as chemical separation, fractional crystallizations, ion-exchange methods and solvent extraction. Apart from the initial chemical separation of cerium and repeated fractional crystallization (time-consuming), nowadays only solvent extraction and ion-exchange methods are used on a commercial scale. Ion-exchange chromatography is not of real commercial importance for large-scale production (disadvantage of being a slow process) but for electronic or spectroscopic use.

Solvent extraction is recognized as an important and main industrial technology for separation and purification of rare earth elements. Acidic organophosphorus extractants, such as tributyl phosphate or di-2-ethylhexyl phosphoric acid (D2EHPA), are widely used for this purpose. Industrially the rare earths are usually recovered from the leach liquor by solvent extraction with 25% D2EHPA in kerosene, followed by multistage recovery of the rare earths from the organic solution and precipitation with oxalic acid. The final step is calcination and transformation of the rare-earth oxalates into oxides. The disadvantages of this approach include the complexity of the process and large scale use of hazardous chemicals (e.g., organophosphorus compounds). A novel process for the extraction and separation of REE that is both economic and ecological is of commercial interest.

Currently, no one can make high-operating-temperature neodymium (NdFeB) magnets without Chinese controlled inputs of separated terbium (Tb) and dysprosium (Dy)—and there are no substitutes for these elements. Standard NdFeB magnets, without Tb or Dy, cannot be used in high temperature applications such as in electric vehicles (EV) critical components. The production of high-value pre-magnetic REE alloys, requires the purchase of separated Tb and Dy oxides from China.

A novel process for the extraction and separation of REE in high yield and purity, that is of an environmentally cleaner design, and overcoming the technical and economic limitations of the existing commercial processes is of commercial interest.

### SUMMARY

The present disclosure broadly relates to a process for the extraction of rare earth elements from a feed material. In an aspect, the present disclosure relates to a process for the extraction of rare earth elements using one or more leaching steps, the separation of the rare earth elements into a heavy and a light REE fraction by selective roasting, and recovery of the rare earth elements. In an aspect, the present disclosure relates to a process for the extraction of rare earth elements using one or more ultrasound assisted leaching steps, the separation of the rare earth elements into a heavy and a light REE fraction by selective roasting, and recovery of the rare earth elements. In an embodiment of the present disclosure, the ultrasound assisted leaching comprises leaching a rare earth element-containing feed material in a caustic solution while sonicating the caustic solution, followed by leaching in an acidic solution while simultaneously sonicating the acidic solution. In an embodiment of the present disclosure, the selective roasting comprises one or more selective roasting steps.

In an aspect, the present disclosure relates to a process for the selective removal of lanthanum and cerium values from a rare earth element-containing material.

In an aspect, the present disclosure relates to a process for the selective removal of the terbium values from a rare earth element-containing material. In an embodiment, the selective removal of the terbium values comprises a precipitation step using NH₄OH.

Also disclosed in the context of the present disclosure are embodiments 1 to 54. Embodiment 1 is a process for extracting one or more rare earth elements from a rare earth element-containing material, the process comprising: leaching the rare earth element-containing material in a caustic solution while sonicating the caustic solution, thereby producing a caustic pregnant solution and a first residue comprising rare earth hydroxides; leaching the residue comprising rare earth hydroxides in a concentrated nitric acid solution while sonicating the nitric acid solution, thereby producing an acidic pregnant solution comprising rare earth nitrates and a second residue; roasting the rare earth nitrates at a temperature ranging from about 280° C. to about 375° C. thereby producing a first roasted residue comprising at least one of rare earth oxides, rare earth oxynitrates and rare earth nitrates; and roasting a residue substantially comprising rare earth nitrates at a temperature ranging from about 200° C. to about 250° C. thereby producing a second roasted residue. Embodiment 2 is the process of embodiment 1, further comprising evaporating the acidic pregnant solution thereby producing a residue comprising the rare earth nitrates. Embodiment 3 is the process of embodiment 1 or 2, further comprising leaching the first roasted residue in water thereby producing an aqueous pregnant solution comprising lanthanum and a lanthanum depleted residue. Embodiment 4 is the process of embodiment 3, further comprising leaching the lanthanum depleted residue in a weak nitric acid solution thereby producing an acidic pregnant solution substantially comprising the rare earth nitrates and a cerium comprising residue. Embodiment 5 is the process of embodiment 4, further comprising evaporating the acidic pregnant solution substantially comprising the rare earth nitrates, thereby providing the residue substantially comprising the rare earth nitrates. Embodiment 6 is the process of any one of embodiments 1 to 5, further comprising leaching the second roasted residue in water, thereby producing an aqueous pregnant solution enriched in nitrates of light rare earth elements (LREE) and a residue enriched in oxynitrates of heavy rare earth elements (HREE). Embodiment 7 is the process of embodiment 6, further comprising leaching the residue enriched in oxynitrates of heavy rare earth elements (HREE) in a nitric acid solution, thereby producing an acidic pregnant solution substantially comprising the nitrates of the heavy rare earth elements (HREE). Embodiment 8 is the process of embodiment 3, wherein the lanthanum comprises lanthanum nitrate (La (NO₃)₃). Embodiment 9 is the process of embodiment 4, wherein the cerium comprising residue is substantially cerium oxide (CeO₂). Embodiment 10 is the process of any one of embodiments 1 to 9, wherein sonicating the caustic solution and the nitric acid solution is performed at a frequency ranging from about 20 to about 200 kHz and an amplitude ranging from 1% to 100%. Embodiment 11 is the process of any one of embodiments 1 to 10, wherein the caustic leaching is performed at temperatures between 20° C. and 140° C. Embodiment 12 is the process of embodiment 1, wherein the nitric acid leaching is performed at a temperature between 20° C. and 90° C. Embodiment 13 is the process of any one of embodiments 1 to 12, further comprising at least one of converting the rare earth element containing material to a higher surface area material, or subjecting the rare earth element-containing material to at least one beneficiation step prior to the leaching to remove any gangue material. Embodiment 14 is the process of embodiment 13, wherein the at least one beneficiation step comprises separation based on optical and magnetic properties, sensor-based sorting, flotation, gravity separation, and comminuting, crushing or grinding. Embodiment 15 is the process of embodiment 6 or 7, wherein the light rare earth oxides comprise Y₂O₃ and Pr₆O₁₁. Embodiment 16 is the process of embodiment 6 or 7, wherein the heavy rare earth oxides comprise Yb₂O₃, Nd₂O₃, Sm₂O₃, Dy₂O₃, Gd₂O₃, and Er₂O₃. Embodiment 17 is the process of any one of embodiments 1 to 16, wherein the rare earth element-containing material comprises rare-earth element bearing ore materials, mine tailings, waste coal ash, or industrial waste materials. Embodiment 18 is the process of any one of embodiments 1 to 17, wherein the caustic solution comprises a caustic soda (NaOH) solution, a caustic KOH solution, or a caustic NH₄OH solution. Embodiment 19 is the process of any one of embodiments 1 to 17, wherein the caustic pregnant solution comprises dissolved sodium phosphate. Embodiment 20 is the process of any one of embodiments 1 to 19, wherein sonicating of the caustic solution is performed using an external sonication probe. Embodiment 21 is the process of any one of embodiments 1 to 20, wherein sonicating of the nitric acid solution is performed using an external sonication probe. Embodiment 22 is the process of embodiment 1, wherein the second residue comprises at least one of Si, Ta and Nb. Embodiment 23 is the process of any one of embodiments 1 to 22, wherein the rare earth element is at least one of scandium (Sc), yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), Erbium (Er), thulium (Tm), ytterbium (Yb), or lutetium (Lu). Embodiment 24 is the process of embodiment 23, wherein the rare earth element-containing material may further comprise a transition metal. Embodiment 25 is the process of embodiment 23 or 24, wherein the rare earth element-containing material may further comprise an actinide metal. Embodiment 26 is the process of any one of embodiments 1 to 25, wherein the rare earth element-containing material comprises a monazite ore material, bastnasite ore material, apatite ore material, or any combination thereof. Embodiment 27 is the process of any one of embodiments 1 to 26, further comprising subjecting the acidic pregnant solution to terbium precipitation step. Embodiment 28 is the process of embodiment 27, wherein the terbium precipitation step is performed using NH₄OH.

Embodiment 29 is a process for extracting one or more rare earth elements from a rare earth element-containing material, the process comprising: leaching the rare earth element-containing material in a caustic solution, thereby producing a caustic pregnant solution and a first residue comprising rare earth hydroxides; leaching the residue comprising rare earth hydroxides in a concentrated nitric acid solution, thereby producing an acidic pregnant solution comprising rare earth nitrates and a second residue; roasting the rare earth nitrates at a temperature ranging from about 280° C. to about 375° C. thereby producing a first roasted residue comprising at least one of rare earth oxides, rare earth oxynitrates and rare earth nitrates; and roasting a residue substantially comprising the rare earth nitrates at a temperature ranging from about 200° C. to about 250° C. thereby producing a second roasted residue. Embodiment 30 is the process of embodiment 29, further comprising evaporating the acidic pregnant solution thereby producing a residue comprising the rare earth nitrates. Embodiment 31 is the process of embodiment 29 or 30, further comprising leaching the first roasted residue in water thereby producing an aqueous pregnant solution comprising lanthanum and a lanthanum depleted residue. Embodiment 32 is the process of embodiment 31, further comprising leaching the lanthanum depleted residue in a weak nitric acid solution thereby producing an acidic pregnant solution substantially comprising rare earth nitrates and a cerium comprising residue. Embodiment 33 is the process of embodiment 32, further comprising evaporating the acidic pregnant solution substantially comprising the earth nitrates, thereby providing the residue substantially comprising the rare earth nitrates. Embodiment 34 is the process of any one of embodiments 29 to 33, further comprising leaching the second roasted residue in water, thereby producing an aqueous pregnant solution enriched in nitrates of light rare earth elements (LREE) and a residue enriched in oxynitrates of heavy rare earth elements (HREE). Embodiment 35 is the process of embodiment 34, further comprising leaching the residue enriched in oxynitrates of heavy rare earth elements (HREE) in a nitric acid solution, thereby producing an acidic pregnant solution substantially comprising the nitrates of the heavy rare earth elements (HREE). Embodiment 36 is the process of embodiment 31, wherein the lanthanum comprises lanthanum nitrate (La (NO₃)₃). Embodiment 37 is the process of embodiment 32, wherein the cerium comprising residue is substantially cerium oxide (CeO₂). Embodiment 38 is the process of any one of embodiments 29 to 37, wherein sonicating the caustic solution and the nitric acid solution is performed at a frequency ranging from about 20 to about 200 kHz and an amplitude ranging from 1% to 100%. Embodiment 39 is the process of any one of embodiments 29 to 38, wherein the caustic leaching is performed at temperatures between 20° C. and 140° C. Embodiment 40 is the process of embodiment 29, wherein the nitric acid leaching is performed at a temperature between 20° C. and 90° C. Embodiment 41 is the process of any one of embodiments 29 to 40, further comprising at least one of converting the rare earth element containing material to a higher surface area material, or subjecting the rare earth element-containing material to at least one beneficiation step prior to the leaching to remove any gangue material. Embodiment 42 is the process of embodiment 41, wherein the at least one beneficiation step comprises separation based on optical and magnetic properties, sensor-based sorting, flotation, gravity separation, and comminuting, crushing or grinding. Embodiment 43 is the process of embodiment 34 or 35, wherein the light rare earth oxides comprise Y₂O₃ and Pr₆O₁₁. Embodiment 44 is the process of embodiment 34 or 35, wherein the heavy rare earth oxides comprise Yb₂O₃, Nd₂O₃, Sm₂O₃, Dy₂O₃, Gd₂O₃, and Er₂O₃. Embodiment 45 is the process of any one of embodiments 29 to 44, wherein the rare earth element-containing material comprises rare-earth element bearing ore materials, mine tailings, waste coal ash, or industrial waste materials. Embodiment 46 is the process of any one of embodiments 29 to 45, wherein the caustic solution comprises a caustic soda (NaOH) solution a caustic KOH solution or a caustic NH₄OH solution. Embodiment 47 is the process of any one of embodiments 29 to 45, wherein the caustic pregnant solution comprises dissolved sodium phosphate. Embodiment 48 is the process of embodiment 29, wherein the second residue comprises at least one of Si, Ta and Nb. Embodiment 49 is the process of any one of embodiments 29 to 48, wherein the rare earth element is at least one of scandium (Sc), yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), Erbium (Er), thulium (Tm), ytterbium (Yb), or lutetium (Lu). Embodiment 50 is the process of embodiment 49, wherein the rare earth element-containing material may further comprise a transition metal. Embodiment 51 is the process of embodiment 49 or 50, wherein the rare earth element-containing material may further comprise an actinide metal. Embodiment 52 is the process of any one of embodiments 29 to 51, wherein the rare earth element-containing material comprises a monazite ore material, bastnasite ore material, apatite ore material, or any combination thereof. Embodiment 53 is the process of any one of embodiments 29 to 52, further comprising subjecting the acidic pregnant solution to terbium precipitation step. Embodiment 54 is the process of embodiment 53, wherein the terbium precipitation step is performed using NH₄OH.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this specification and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The foregoing and other advantages and features of the present disclosure will become more apparent upon reading of the following non-restrictive detailed description of illustrative embodiments thereof, with reference to the accompanying drawings/figures. It should be understood, however, that the detailed description and the illustrative embodiments, while indicating specific embodiments of the disclosure, are given by way of illustration only, since various changes and modifications within the spirit and scope of the disclosure will become apparent to those skilled in the art from this description.

### BRIEF DESCRIPTION OF THE DRAWINGS/FIGURES

The following figures/drawings form part of the present specification and are included to further demonstrate certain aspects of the present specification. The present specification may be better understood by reference to one or more of these figures/drawings in combination with the detailed description. In the appended drawings/figures:

FIG. 1—Illustration of a flowchart illustrating the process for the extraction and separation of the rare earth elements into a heavy and light REE fraction, in accordance with an embodiment of the present disclosure.

FIG. 2—Illustration of lanthanum removal following water leaching in accordance with an embodiment of the present disclosure. About 45% of the lanthanum values can be removed with insignificant losses of valuable rare earth elements.

FIG. 3—Illustration of cerium removal following weak nitric acid leaching in accordance with an embodiment of the present disclosure. About 97.6% of the cerium values can be removed with insignificant losses of valuable rare earth elements.

FIG. 4—Illustration of the partial separation of the LREE (e.g., Nd, Pr, Sm, Eu) from some of the HREE (e.g., Er, Tm, Yb, Lu) following roasting/water leaching in accordance with an embodiment of the present disclosure.

FIG. 5—Illustration of the partial separation of the LREE (e.g., Nd, Pr, Sm, Eu) from some of the HREE (e.g., Er, Tm, Yb, Lu) following a further roasting/water leaching on the LREE concentrate in accordance with an embodiment of the present disclosure.

FIG. 6—Illustration of a flowchart illustrating the process for the extraction and separation of the rare earth elements into a heavy and light REE fraction, in accordance with an embodiment of the present disclosure.

### DETAILED DESCRIPTION OF ILLUSTRATIVE EMBODIMENTS

The present disclosure relates to a process for the extraction and recovery of rare earth elements from a feed material.

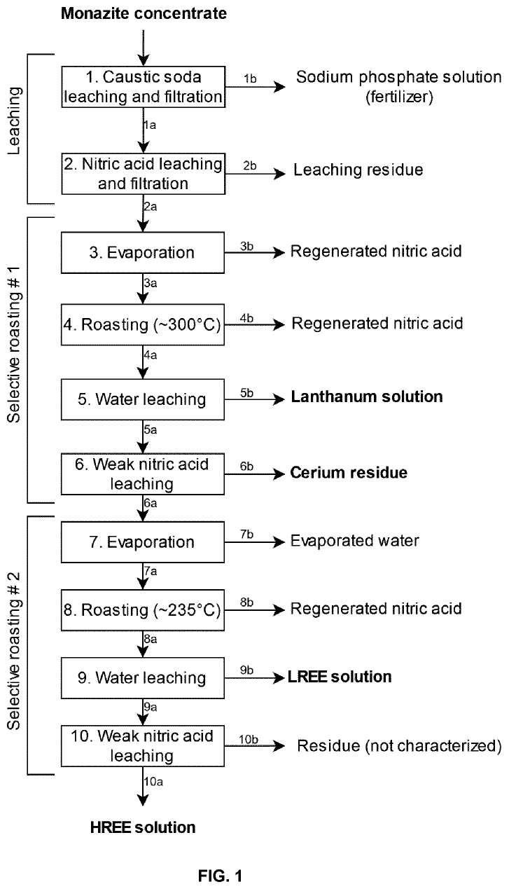

In an aspect, and with reference to FIG. 1, the present disclosure relates to a process for the extraction of rare earth elements using one or more leaching steps, the separation of the rare earth elements into a heavy and a light REE fraction by selective roasting, and recovery of the rare earth elements. In an aspect, the present disclosure relates to a process for the extraction of rare earth elements using one or more ultrasound assisted leaching steps, the separation of the rare earth elements into a heavy and a light REE fraction by selective roasting, and recovery of the rare earth elements. In an aspect of the present disclosure, the process for the extraction and recovery of rare earth elements comprises one or more ultrasound assisted leaching steps. In an embodiment of the present disclosure, the ultrasound assisted leaching comprises leaching a rare earth element-containing feed material in a caustic solution while sonicating the caustic solution, followed by leaching in an acidic solution while simultaneously sonicating the acidic solution. In an aspect of the present disclosure, the process for the extraction and recovery of rare earth elements comprises one or more selective roasting steps. In a further aspect of the present disclosure, the process for the extraction and recovery of rare earth elements comprises separating the rare earth elements into a light and a heavy REE fraction by one or more selective roasting steps. These and other aspects of the disclosure are described in greater detail below.

In an aspect, and with reference to FIG. 6, the present disclosure relates to a process for the extraction of rare earth elements using one or more leaching steps, the separation of the rare earth elements into a heavy and a light REE fraction by selective roasting, and recovery of the rare earth elements. In an aspect, the present disclosure relates to a process for the extraction of rare earth elements using one or more ultrasound assisted leaching steps, the removal of the terbium values by selective precipitation using NH₄OH, the separation of the rare earth elements into a heavy and a light REE fraction by selective roasting, and recovery of the rare earth elements. In an aspect of the present disclosure, the process for the extraction and recovery of rare earth elements comprises one or more ultrasound assisted leaching steps. In an embodiment of the present disclosure, the ultrasound assisted leaching comprises leaching a rare earth element-containing feed material in a caustic solution while sonicating the caustic solution, followed by leaching in an acidic solution while simultaneously sonicating the acidic solution. In a further aspect of the present disclosure, the process for the extraction and recovery of rare earth elements comprises a terbium precipitation step using NH₄OH. In an aspect of the present disclosure, the process for the extraction and recovery of rare earth elements comprises one or more selective roasting steps. In a further aspect of the present disclosure, the process for the extraction and recovery of rare earth elements comprises separating the rare earth elements into a light and a heavy REE fraction by one or more selective roasting steps. These and other aspects of the disclosure are described in greater detail below.

An XRF analysis of a RE concentrate from a monazite deposit located in the province of Vichada, Colombia is illustrated in Table 1. The concentrate comprises a high concentration in REE with roughly 50% of the mass of the sample being rare earth oxides (REO). Other elements of interest in the concentrate are tantalum (2.18%), niobium (2.07%), zirconium (1.13%), hafnium (0.26%) and radioactive elements (uranium, 0.36%; thorium, 8.26%).

TABLE 1
Composition of a monazite RE concentrate.

| | Concentration (%) |
|---|---|
| CeO₂ | 26.58 |
| P₂O₅ | 15.74 |
| Fe₂O₃ | 10.75 |
| Nd₂O₃ | 8.73 |
| ThO₂ | 8.26 |
| La₂O₃ | 6.56 |
| SiO₂ | 4.59 |
| Al₂O₃ | 2.41 |
| Ta₂O₅ | 2.18 |
| Nb₂O₅ | 2.07 |
| Pr₆O₁₁ | 2.02 |
| Sm₂O₃ | 1.86 |
| ZrO₂ | 1.13 |
| Yb₂O₃ | 1.03 |
| Y₂O₃ | 0.92 |
| Gd₂O₃ | 0.79 |
| Dy₂O₃ | 0.77 |
| SnO₂ | 0.64 |
| PbO | 0.64 |
| Bi₂O₃ | 0.52 |
| Er₂O₃ | 0.38 |
| CaO | 0.38 |
| UO₂ | 0.36 |
| HfO₂ | 0.26 |
| WO₃ | 0.18 |
| TiO₂ | 0.15 |
| MnO | 0.06 |
| TOTAL | 99.96% |

The distribution of the light and heavy REE obtained following treatment of the monazite deposit illustrated in Table 1 in accordance with an embodiment of the present disclosure is illustrated in Table 2. The process comprises the steps of ultrasound enhanced leaching and calcination (“roasting”). As illustrated in Table 2, commercial concentrates of both light and heavy REE can be advantageously obtained using the process described herein.

TABLE 2
Distribution of light and heavy REE from monazite deposit.

| | Nd | Pr | Dy | Tb | Y | La | Ce | Sm | Gd | Er |
|---|---|---|---|---|---|---|---|---|---|---|
| Light | 46.9% | 14.0% | 1.0% | 0.49% | 1.1% | 23.1% | 1.3% | 8.7% | 2.8% | 0.2% |
| REE | | | | | | | | | | |
| Heavy | 14.9% | 0.0% | 16.1% | 3.42% | 12.4% | 0.0% | 8.5% | 9.8% | 10.3% | 7.5% |
| REE | | | | | | | | | | |

The heavy REE concentrates are of great significance as they are necessary in order to reduce heat in magnets, allowing the EV's to move forward. In an aspect of the present disclosure, the process comprises a pre-processing separation step, advantageously providing for the separation of monazite from the feed material. Several separation techniques may be employed for the pre-processing of the rare earth element-containing feed material, non-limiting examples of which include microwave pre-treatment, gravity separation, magnetic separation, froth flotation, and optical separation. Microwave pre-treatment is used to pre-weaken the feed material by triggering the formation of microcracks therein, thereby increasing the surface to volume ratio. Gravity separation takes advantage of the differences in the specific gravities (relative densities) of the components of the feed material. It is of relatively low cost, does not involve any chemicals, and does not have any heating requirements. Magnetic separation takes advantage of the different behaviors of the components of the feed material when subjected to a magnetic field. Magnetic separation is advantageously used to remove iron (i.e., magnetite; Fe²⁺(Fe³⁺)₂(O²⁻)₄) from the feed material prior to subjecting the feed material to the ultrasound assisted extraction. Froth flotation is a complex, three-phase (solids, water, and air) separation process, that exploits natural and induced differences in the wettability of the components of the feed material. Optical separation takes advantage of the color differences of the components of the feed material. In an embodiment of the present disclosure, gravity, optical and/or magnetic separation are advantageously used in the pre-processing of the rare earth element-containing feed material. In a further embodiment of the present disclosure, pre-processing comprises a grinding step. The grinding step may be advantageously achieved using a ball mill grinder. In a further embodiment of the present disclosure, the feed material is ground to a particle size ranging from about 3 mm to 60 microns. In yet a further embodiment of the present disclosure, the feed material is advantageously ground to a particle size of 60 microns. Grinding of the feed material provides for increasing the surface area of the feed material available for the subsequent extraction step(s), in turn providing for enhanced leaching rates.

In an embodiment, the process advantageously comprises a precipitation step for the selective removal of the terbium values by selective precipitation using NH₄OH. In an embodiment of the present disclosure, the process advantageously comprises one or more selective roasting steps. Selective roasting advantageously provides for the preparation of concentrates of selected rare earth elements (e.g., a lanthanum concentrate, a concentrate of LREE, and a concentrate of HREE). Moreover, the selective roasting advantageously provides for a residue/precipitate substantially composed of cerium. Selective roasting advantageously provides for the selective thermal decomposition of nitrate rare earth salts into the corresponding rare earth oxynitrates and finally the corresponding rare earth oxides:

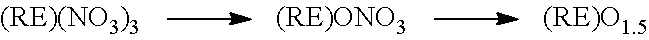

Each of the individual REE nitrates has its proper decomposition temperature such that roasting at selected temperatures provides for selectively oxidizing certain REE into the corresponding oxynitrates and oxides, while maintaining others as soluble nitrates.

In an embodiment of the present disclosure, and with reference to FIGS. 1 and 6, the process may be broadly divided into two (2) main sections: (1) a first section (“pre-processing”) handling early separation and beneficiation of the rare earth element-containing feed material (e.g., ore material); and (2) a second section (“processing”) handling the ultrasound assisted extraction of the rare earth values and selective roasting thereof. In the first section, the rare earth element-containing feed material may be subjected to one or more optical and/or gravimetric and/or magnetic separation techniques, followed by a grinding operation. In the second section, the feed material is subjected to ultrasound assisted extraction (“leaching”). In an embodiment of the present disclosure, the ultrasound assisted extraction comprises caustic soda (NaOH) leaching, and nitric acid (HNO₃) leaching. In further embodiments of the present disclosure, the caustic leaching may be performed using KOH or NH₄OH. The second section further comprises one or more roasting steps. In an embodiment of the present disclosure, a first roasting step advantageously provides for the selective removal of the cerium and lanthanum values. In a further embodiment of the present disclosure, the first roasting step comprises an evaporation step, a roasting step, a water (H₂O) leaching step, and a nitric acid (HNO₃) leaching step. In an embodiment of the present disclosure, a second roasting step advantageously provides for a concentrate of light REE and heavy REE. In a further embodiment of the present disclosure, the second roasting step comprises an evaporation step, a roasting step, a water (H₂O) leaching step, and a nitric acid (HNO₃) leaching step. In a further embodiment of the present disclosure (FIG. 6), the second section further comprises a terbium precipitation step for removal of the terbium values by selective precipitation using NH₄OH.

Caustic soda leaching. Caustic soda (NaOH) is mixed with water at high temperature (140° C.) to obtain a solution having a concentration of at least 50% (w/w). The monazite concentrate (a phosphate mineral containing rare earth elements) is subsequently leached in the caustic soda solution while simultaneously sonicating the caustic soda solution (Ultrasound assisted extraction—UAEx). In an embodiment, the caustic soda leaching is performed over a period of 2 hours. The leaching results in the formation of insoluble rare earth hydroxides. The phosphate from the monazite is found in the pregnant leach solution as sodium phosphate. Following a filtration step, the solids comprising the rare earth hydroxides are washed and subsequently subjected to nitric acid (HNO₃) leaching (cf. stream 1a). In excess of 99 wt. % of the rare earth values present in the monazite concentrate are recovered in the solids. The sodium phosphate can be recovered from the solution and used as fertilizer (cf. stream 1b). Up to 89 wt. % of the phosphate present in the monazite concentrate was advantageously recovered as sodium phosphate.

Nitric acid leaching. The solids recovered from the caustic soda leaching are subjected to nitric acid leaching while simultaneously sonicating the nitric acid solution (Ultrasound assisted extraction—UAEx). In an embodiment of the present disclosure, a solution of 63% (w/w) nitric acid is used. In an embodiment, the nitric acid leaching is performed over a period of 2 hours. The pregnant leach solution (PLS) is subsequently filtered and the solid washed. The resulting pregnant leach solution comprises the rare earth values as rare earth nitrates. In excess of 91 wt. % of the rare earth values present in the monazite concentrate are recovered in the pregnant leach solution (cf. stream 2a). The composition of the rare earth values in the pregnant leach solution is illustrated in Table 3. The solid residue (cf. stream 2b) comprises mostly unleachable elements such as Si, Ta, Nb.

TABLE 3
Distribution of the Rare Earth Values in the PLS following nitric acid leaching.

| Sc | Y | La | Ce | Nd | Pr | Sm | Eu | Gd | Tb | Dy | Ho | Er | Tm | Yb | Lu |
|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) |
| 0.0 | 1.4 | 14.7 | 47.3 | 20.3 | 5.8 | 4.2 | 0.0 | 1.9 | 0.4 | 1.6 | 0.2 | 0.7 | 0.1 | 1.2 | 0.2 |

### First Selective Roasting—Removal of the Lanthanum and Cerium Values (FIG. 1)

Evaporation. The pregnant leach solution (cf. stream 2a) is concentrated until a moist residue comprising the rare earth nitrate salts is obtained (cf. stream 3a). The nitric acid is advantageously recycled back into the process for further leaching of rare earth metal containing material (cf. stream 3b).

Roasting. The rare earth nitrate salts (cf. stream 3a) are subjected to a roasting step resulting in the formation of rare earth metal oxides, rare earth metal oxynitrates and rare earth metal nitrates (cf. stream 4a). In an embodiment of the present disclosure, the roasting is performed at temperatures ranging between about 280° C. and about 375° C. In an embodiment, the roasting is performed at 350° C. Stream 4b, comprising H₂O(g) and NOx gases may be recycled back into the process.

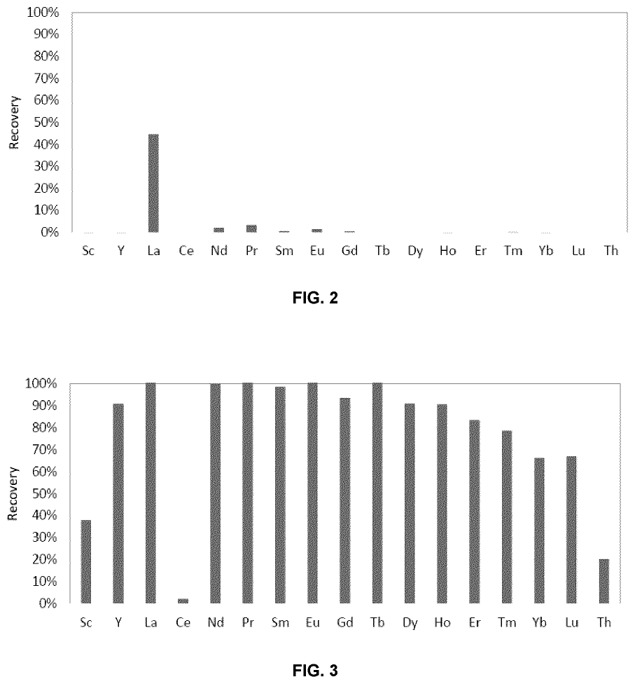

Water leaching. The roasted residue comprising rare earth metal oxides, rare earth metal oxynitrates and rare earth metal nitrates are subjected to water leaching. In an embodiment of the present disclosure the water leaching is performed at temperatures ranging between about 20° C. and about 90° C. In a further embodiment of the present disclosure, the water leaching is performed at 90° C. In a further embodiment of the present disclosure, the water leaching is performed over a period of time ranging from 15 minutes to 2 hours. In a further embodiment of the present disclosure, the water leaching is performed over a period of about 1 hour. In a further embodiment of the present disclosure, the water leaching is performed over a period of about 45 minutes. In a further embodiment of the present disclosure, the water leaching is performed over a period of about 30 minutes. The leaching step advantageously provides for the selective removal of the rare earth metal nitrates. In an embodiment of the present disclosure, the leaching provides for the selective removal of the lanthanum values (cf. Table 4). To that effect, the rare earth values present in the pregnant leach solution obtained following water leaching are illustrated in Table 4. As can be gleaned from the data illustrated in Table 4, about 45 wt. % of the lanthanum can be removed with insignificant losses of valuable rare earth elements (FIG. 2).

TABLE 4
Rare earth values of the PLS following water leaching.

| Sc | Y | La | Ce | Nd | Pr | Sm | Eu | Gd | Tb | Dy | Ho | Er | Tm | Yb | Lu | Th |
|---|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) | (%) |
| 0.3 | 0.2 | 44.7 | 0.0 | 2.1 | 3.4 | 0.7 | 1.5 | 0.4 | 0.0 | 0.1 | 0.3 | 0.0 | 0.3 | 0.3 | 0.0 | 0.1 |

Stream 5a, is composed of a residue comprising the rare earth values, substantially devoid of lanthanum. In an embodiment of the present disclosure, substantially all of the rare earth values, with the exception of the lanthanum values, are present in the residue of stream 5a. This residue is subjected to further nitric acid leching. Stream 5b comprises the filtered pregnant solution. As illustrated in Table 5, the pregnant solution comprises significant amounts of dissolved lanthanum, and only relatively minor amount of other rare earth values.

TABLE 5
Rare Earth Values in the filtered PLS following water leaching.

| Sc | Y | La | Ce | Nd | Pr | Sm | Eu | Gd | Tb | Dy | Ho | Er | Tm | Yb | Lu |
|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) |
| 0.0 | 0.0 | 90.6 | 0.0 | 6.0 | 2.7 | 0.4 | 0.0 | 0.1 | 0.0 | 0.0 | 0.0 | 0.0 | 0.0 | 0.0 | 0.0 |

Weak Nitric Acid Leaching. The residue of stream 5a (i.e., residue comprising the rare earth values, substantially devoid of lanthanum) is subjected to weak nitric acid leaching (concentrations ≤0.5M). In an embodiment of the present disclosure the nitric acid leaching is performed at a pH of about 1. In an embodiment of the present disclosure the nitric acid leaching is performed at temperatures ranging between about 20° C. and about 90° C. In a further embodiment of the present disclosure, the nitric acid leaching is performed at 90° C. In a further embodiment of the present disclosure, the nitric acid leaching is performed over a period of time ranging from 15 minutes to 2 hours. In a further embodiment of the present disclosure, the nitric acid leaching is performed over a period of about 1 hour. In a further embodiment of the present disclosure, the nitric acid leaching is performed over a period of about 45 minutes. In a further embodiment of the present disclosure, the nitric acid leaching is performed over a period of about 30 minutes. The nitric acid leaching advantageously provides for the selective leaching of the rare earth oxynitrates (stream 6a) with only trace amounts of cerium (FIG. 3). The solid residue remaining following the leaching comprises substantially (about 97.6%) cerium oxide (cf. stream 6b). In an embodiment of the present disclosure, the leaching provides for the selective removal of the cerium values (cf. Table 6). To that effect, the rare earth values in the pregnant leach solution obtained following weak nitric acid leaching (cf. stream 6a) is illustrated in Tables 6 and 7. The pregnant leach solution may be further processed to obtain leach solutions comprising the LREE and HREE respectively.

TABLE 6
Rare Earth Values in the PLS following nitric acid leaching.

| Sc | Y | La | Ce | Nd | Pr | Sm | Eu | Gd | Tb | Dy | Ho | Er | Tm | Yb | Lu |
|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) |
| 0.0 | 2.7 | 20.0 | 2.3 | 42.6 | 12.1 | 8.8 | 0.1 | 3.8 | 0.9 | 3.0 | 0.4 | 1.2 | 0.2 | 1.7 | 0.2 |

TABLE 7
Recovery of the Rare Earth values following nitric acid leaching.

| Sc | Y | La | Ce | Nd | Pr | Sm | Eu | Gd | Tb | Dy | Ho | Er | Tm | Yb | Lu | Th |
|---|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) | (%) |
| 37.9 | 90.8 | 100 | 2.2 | 99.9 | 100 | 98.6 | 100 | 93.4 | 100 | 90.9 | 90.5 | 83.4 | 78.5 | 66.2 | 67.0 | 20.4 |

As illustrated in Table 8, the residue (cf. stream 6b) comprises significant amounts of cerium, and only relatively minor amount of other rare earth values. As can be gleaned from the data illustrated in Table 8, about 98% of the cerium can be removed with insignificant losses of valuable rare earth elements.

TABLE 8
Composition of the residue following nitric acid leaching.

| Sc | Y | La | Ce | Nd | Pr | Sm | Eu | Gd | Tb | Dy | Ho | Er | Tm | Yb | Lu |
|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) |
| 0.1 | 0.3 | 0.0 | 97.6 | 0.0 | 0.0 | 0.1 | 0.0 | 0.3 | 0.0 | 0.3 | 0.0 | 0.2 | 0.1 | 0.9 | 0.1 |

### Second Selective Roasting—Generation of LREE and HREE Concentrates

Evaporation. The pregnant leach solution (cf. stream 6a) is concentrated until a moist residue comprising the rare earth nitrates is obtained (cf. stream 7a). The nitric acid and water are advantageously recycled back into the process for further leaching of rare earth metal containing material cf. (cf. stream 7b).

Roasting. The rare earth nitrates (cf. stream 7a) are subjected to a further roasting step, substantially resulting in the formation of rare earth metal oxynitrates (cf. stream 8a). In an embodiment of the present disclosure, the roasting is performed at temperatures ranging between about 200° C. and about 250° C. In an embodiment, the roasting is performed at 235° C. Stream 8b, comprising H₂O(g) and NOx gases may be recycled back into the process.

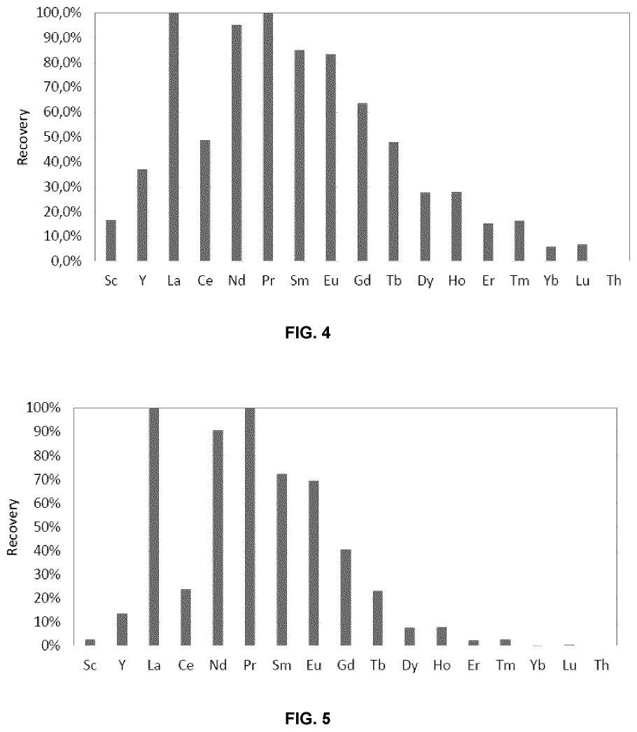

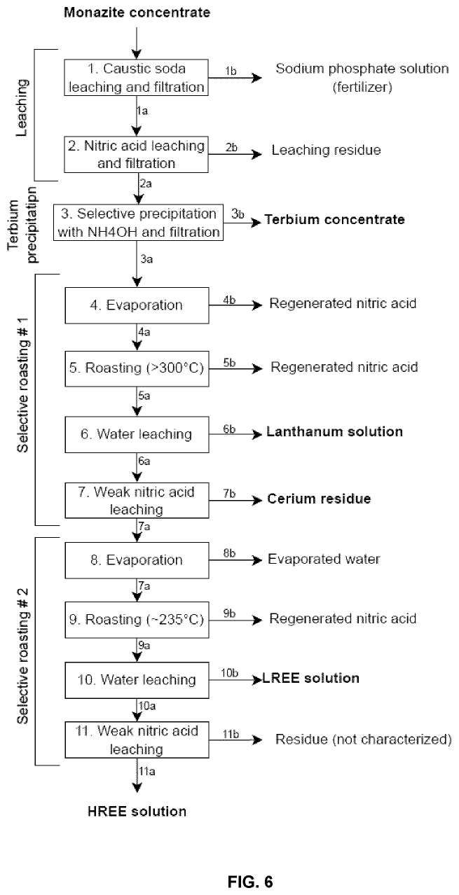

Water leaching. The roasted residue (cf. stream 8a) comprising the rare earth metal oxynitrates is subjected to water leaching. In an embodiment of the present disclosure the water leaching is performed at temperatures ranging between about 30° C. and about 90° C. In a further embodiment of the present disclosure, the water leaching is performed at 90° C. In a further embodiment of the present disclosure, the water leaching is performed over a period of time ranging from 15 minutes to 2 hours. In a further embodiment of the present disclosure, the water leaching is performed over a period of about 1 hour. In a further embodiment of the present disclosure, the water leaching is performed over a period of about 45 minutes. In a further embodiment of the present disclosure, the water leaching is performed over a period of about 30 minutes. The leaching step advantageously provides for the partial separation of the LREE (e.g., Nd, Pr, Sm, Eu) from some of the HREE (e.g., Y, Gd, Tb, Dy, Ho, Er, Tm, Yb, Lu). To that effect, the pregnant solution obtained following the water leaching (cf. stream 9b) will substantially comprise the LREE, whereas the HREE are substantially present in the remaining solid residue (cf. stream 9a). The composition of the light rare earth values in the pregnant solution obtained following water leaching is illustrated in Table 9. In an embodiment of the present disclosure, the second selective roasting/leaching may be repeated on the LREE concentrate in order to obtain a better separation of the LREE and HREE (FIGS. 4 and 5).

TABLE 9
Distribution LREE Values in the PLS following water leaching.

| Sc | Y | La | Ce | Nd | Pr | Sm | Eu | Gd | Tb | Dy | Ho | Er | Tm | Yb | Lu |
|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) |
| 0.0 | 1.1 | 23.1 | 1.3 | 46.9 | 14.0 | 8.7 | 0.1 | 2.8 | 0.5 | 1.0 | 0.1 | 0.2 | 0.0 | 0.1 | 0.0 |

Weak Nitric Acid Leaching. The residue of stream 9a (i.e., residue comprising the oxynitrate HREE values) is subjected to weak nitric acid leaching (concentrations ≤0.5M). In an embodiment of the present disclosure the nitric acid leaching is performed at a pH of about 1. In an embodiment of the present disclosure the nitic acid leaching is performed at temperatures ranging between about 30° C. and about 90° C. In a further embodiment of the present disclosure, the nitric acid leaching is performed at 90° C. In a further embodiment of the present disclosure, the nitric acid leaching is performed over a period of time ranging from 15 minutes to 2 hours. In a further embodiment of the present disclosure, the nitric acid leaching is performed over a period of about 1 hour. In a further embodiment of the present disclosure, the nitric acid leaching is performed over a period of about 45 minutes. In a further embodiment of the present disclosure, the nitric acid leaching is performed over a period of about 30 minutes. The nitric acid leaching advantageously provides for the leaching of the HREE values (cf. stream 10a). Stream 10b comprises the solid residue remaining following nitric acid leaching. The composition of the heavy rare earth values in the pregnant solution obtained following nitric acid leaching (cf. stream 10a) is illustrated in Table 10.

TABLE 10
Distribution HREE Values in the PLS following nitic acid leaching

| Sc | Y | La | Ce | Nd | Pr | Sm | Eu | Gd | Tb | Dy | Ho | Er | Tm | Yb | Lu |
|---|---|---|---|---|---|---|---|---|---|---|---|---|---|---|---|
| (%) | (%) | (%) | (%) | (%) | (%) | (%) | (%) | (%) | (%) | (%) | (%) | (%) | (%) | (%) | (%) |
| 0.2 | 12.4 | 0.0 | 8.5 | 14.9 | 0.0 | 9.8 | 0.1 | 10.3 | 3.4 | 16.1 | 2.0 | 7.5 | 1.3 | 11.9 | 1.6 |

### First Selective Roasting—Removal of the Lanthanum and Cerium Values (FIG. 6)

Evaporation. In an embodiment of the present disclosure, the process comprises a step for the selective removal of the terbium values (cf. Table 11). The pregnant leach solution (cf. stream 2a) is subjected to a terbium precipitation step for removal of the terbium values by selective precipitation using NH₄OH (cf. stream 3b). The resulting terbium depleted pregnant leach solution (cf. stream 3a) is then concentrated until a moist residue comprising the rare earth nitrate salts is obtained (cf. stream 4a). The nitric acid is advantageously recycled back into the process for further leaching of rare earth metal containing material (cf. stream 4b).

Roasting. The rare earth nitrate salts (cf. stream 4a) are subjected to a roasting step resulting in the formation of rare earth metal oxides, rare earth metal oxynitrates and rare earth metal nitrates (stream 5a). In an embodiment of the present disclosure, the roasting is performed at temperatures ranging between about 280° C. and about 375° C. In an embodiment, the roasting is performed at 350° C. Stream 5b, comprising H₂O(g) and NOx gases may be recycled back into the process.

TABLE 11
Rare Earth Values in the PLS following terbium precipitation as a function of pH.

| | Ce | Dy | Er | Eu | Gd | Ho | La | Lu | Nd | Pr | Sc | Sm | Tb | Th | Tm | Y | Yb |
|---|---|---|---|---|---|---|---|---|---|---|---|---|---|---|---|---|---|
| pH | (%) | (%) | (%) | (%) | (%) | (%) | (%) | (%) | (%) | (%) | (%) | (%) | (%) | (%) | (%) | (%) | (%) |
| 1^{a} | 100 | 100 | 100 | 100 | 100 | 100 | 100 | 100 | 100 | 100 | 100 | 100 | 100 | 100 | 100 | 100 | 100 |
| 1.5^{b} | 99.8 | 97.0 | 95.0 | 97.9 | 98.0 | 96.4 | 100 | 58.3 | 99.2 | 99.4 | 97.2 | 98.1 | <10.1 | 90.6 | 98.1 | 97.4 | 98.6 |
| 3.0^{c} | 97.5 | 92.4 | 90.1 | 93.9 | 94.3 | 93.3 | 98.5 | 33.3 | 97.0 | 96.9 | 96.7 | 94.7 | <10.1 | 80.9 | 95.4 | 92.7 | 97.9 |

^{a}Starting pH;
^{b}NH₄OH (30%) 66 kg/t of REE;
^{c}NH₄OH (30%) 131 kg/t of REE;

In an embodiment of the present disclosure, and with reference to FIGS. 1-6, the process may be broadly divided into two main (2) sections: (1) a first section (“pre-processing”) handling early separation and beneficiation of the rare earth element-containing feed material (e.g., ore material); and (2) a second section (“processing”) handling the ultrasound assisted extraction of the rare earth values and selective roasting thereof. In the first section, the rare earth element-containing feed material may be subjected to one or more optical and/or gravimetric and/or magnetic separation techniques, followed by a grinding operation. In the second section, the feed material is subjected to ultrasound assisted extraction (“leaching”). In an embodiment of the present disclosure, the ultrasound assisted extraction comprises caustic soda (NaOH) leaching, and nitric acid (HNO₃) leaching. The second section further comprises one or more roasting steps. The second section may further comprise a terbium precipitation step for removal of the terbium values by selective precipitation using NH₄OH. In an embodiment of the present disclosure, a first roasting step advantageously provides for the selective removal of the lanthanum and cerium values. In a further embodiment of the present disclosure, the first roasting step comprises an evaporation step, a roasting step, a water (H₂O) leaching step, and a weak nitric acid (HNO₃) leaching step. In an embodiment of the present disclosure, a second roasting step advantageously provides for a concentrate of light REE and heavy REE. In a further embodiment of the present disclosure, the second roasting step comprises an evaporation step, a roasting step, a water (H₂O) leaching step, and a weak nitric acid (HNO₃) leaching step.

With reference to the first section of the process, several separation techniques may be employed for the pre-processing of the rare earth element-containing feed material, non-limiting examples of which include microwave pre-treatment, gravity separation, magnetic separation, froth flotation, and optical separation. Microwave pre-treatment is used to pre-weaken the feed material by triggering the formation of microcracks therein, thereby increasing the surface to volume ratio. Gravity separation takes advantage of the differences in the specific gravities (relative densities) of the components of the feed material. It is of relatively low cost, does not involve any chemicals, and does not have any heating requirements. Gravity separation may be advantageously used to remove uranium (i.e., uranium oxide) from the feed material prior to subjecting the feed material to the ultrasound assisted extraction. Magnetic separation takes advantage of the different behaviors of the components of the feed material when subjected to a magnetic field. Magnetic separation is advantageously used to remove iron (i.e., magnetite; Fe²⁺(Fe³⁺)₂(O²⁻)₄) from the feed material prior to subjecting the feed material to the ultrasound assisted extraction. Froth flotation is a complex, three-phase (solids, water, and air) separation process, that exploits natural and induced differences in the wettability of the components of the feed material. Optical separation takes advantage of the color differences of the components of the feed material. In an embodiment of the present disclosure, gravity, optical and/or magnetic separation are advantageously used in the pre-processing of the rare earth element-containing feed material. In a further embodiment of the present disclosure, pre-processing comprises a grinding step. The grinding step may be advantageously achieved using a ball mill grinder. In a further embodiment of the present disclosure, the feed material is ground to a particle size ranging from about 3 mm to 60 microns. In yet a further embodiment of the present disclosure, the feed material is advantageously ground to a particle size of 60 microns. Grinding of the feed material provides for increasing the surface area of the feed material available for the subsequent extraction (leaching) step, in turn providing for enhanced leaching rates.

With reference to the second section of the process, and with reference to FIGS. 1 and 6, the rare earth element-containing feed material is subjected to an ultrasound assisted extraction step comprising caustic soda (NaOH) leaching, and nitric acid (HNO₃) leaching. The solids recovered from the caustic soda leaching are subjected to nitric acid leaching while simultaneously sonicating the nitric acid solution (Ultrasound assisted extraction—UAEx). This step comprises mixing of the material with an aqueous nitric acid solution to provide a slurry and subsequently sonicating the slurry while stirring. The sonication advantageously provides for increased leaching rates, shorter extraction times, and reduced acid consumption. Sonication generates cavitation bubbles which aid in breaking up and/or causing the formation of cracks in the material which increases the surface area of the material resulting in enhanced leaching rates. In an embodiment of the present disclosure, the nitric acid leaching/sonication step is performed as a batch process. Following the ultrasound assisted extraction step, a pregnant leach solution comprising rare earth element salts is obtained. In an embodiment of the present disclosure, the ultrasound assisted extraction (caustic soda (NaOH) leaching and/or nitric acid (HNO₃) leaching) may be performed at temperatures between 20° C. and 100° C. In a further embodiment of the present disclosure, the caustic soda (NaOH) leaching and/or nitric acid (HNO₃) leaching may be performed at temperatures between 20° C. and 90° C.

The ultrasound assisted extraction steps, more specifically the ultrasound assisted caustic soda (NaOH) leaching may be advantageously conducted using a 50% (w/w) caustic soda solution. The ultrasound assisted extraction steps, more specifically the ultrasound assisted nitric acid (HNO₃) leaching may be advantageously conducted using a 63% (w/w) nitric acid solution.

In an embodiment of the present disclosure, the rare earth element-containing feed material may be monazite. In further embodiments of the present disclosure, the rare earth element-containing feed material may be cheralite, huttonite, xenotime, coesite, ilite, smectite, bastnaesite, samarskite and/or gadolinium neodymium dizirconate and/or recycled materials (e.g., electronics). The monazite feed material comprises several of the following compounds: Al₂O₃, BaO, Bi₂O₃, CaO, CeO₂, Dy₂O₃, Er₂O₃, Fe₂O₃, Gd₂O₃, HfO₂, K₂O, La₂O₃, MgO, Nb₂O₅, Nd₂O₃, P₂O₅, PbO, Pr₆O₁₁, SiO₂, Sm₂O₃, SnO₂, SrO, Ta₂O₅, ThO₂, TiO₂, UO₂, H₂O, WO₃, Y₂O₃ and Yb₂O₃.

In an embodiment of the present disclosure, the acid leaching/sonication step is performed using nitric acid (HNO₃), converting the compounds of the monazite feed material into the corresponding nitrates. In a further embodiment of the present disclosure, the initial nitric acid leaching/sonication may be advantageously performed using a nitric acid concentration ranging between about 10M and about 20M, at a temperature ranging between about 50° C. and about 70° C., over a time ranging from about 30 minutes to about 120 minutes, and at an amplitude of about 80%.

In embodiments of the present disclosure, the leaching solution comprises from about 5 wt. % to about 100 wt. % HNO₃; in a further embodiment from about 5 wt. % to about 90 wt. % HNO₃; in a further embodiment from about 10 wt. % to about 80 wt. % HNO₃; in a further embodiment from about 15 wt. % to about 70 wt. % HNO₃; in a further embodiment from about 20 wt. % to about 60 wt. % HNO₃; in a further embodiment from about 30 wt. % to about 50 wt. % HNO₃; about 5 wt. % HNO₃; about 10 wt. % HNO₃; about 15 wt. % HNO₃; about 20 wt. % HNO₃; about 25 wt. % HNO₃; about 30 wt. % HNO₃; about 35 wt. % HNO₃; about 40 wt. % HNO₃; about 45 wt. % HNO₃; about 50 wt. % HNO₃; about 55 wt. % HNO₃; about 60 wt. % HNO₃; about 65 wt. % HNO₃; about 70 wt. % HNO₃; about 75 wt. % HNO₃; about 80 wt. % HNO₃; about 85 wt. % HNO₃; about 90 wt. % HNO₃; about 95 wt. % HNO₃; or about 100 wt. % HNO₃.

In an embodiment of the present disclosure, the ultrasound-assisted extractions (caustic soda (NaOH) leaching, and nitric acid (HNO₃) leaching) may be advantageously performed at the natural frequency of the rare earth element-containing feed material. In further embodiments of the present disclosure, the sonication is performed at a frequency ranging from about 20 to about 200 kHz, from about 30 to about 200 kHz; from about 40 to about 200 kHz; from about 50 to about 200 kHz, from about 60 to about 200 kHz; from about 70 to about 200 kHz; from about 80 to about 200 kHz, from about 90 to about 200 kHz; from about 100 to about 200 kHz; from about 110 to about 200 kHz, from about 120 to about 200 kHz; from about 130 to about 200 kHz; from about 140 to about 200 kHz; from about 150 to about 200 kHz, from about 160 to about 200 kHz; from about 170 to about 200 kHz; from about 180 to about 200 kHz; about 20 kHz; about 30 kHz; about 40 kHz; about 50 kHz; about 60 kHz; about 70 kHz; about 80 kHz; about 90 kHz; about 100 kHz; about 110 kHz; about 120 kHz; about 130, about 140 kHz; about 150 kHz; about 160 kHz; about 170 kHz; about 180, about 190 kHz; or about 200 kHz.

In an embodiment of the present disclosure, the ultrasound-assisted extraction may be advantageously performed at an amplitude ranging from about 1% to about 100%; from about 5% to about 100%; from about 10% to about 100%; from about 15% to about 100%; from about 20% to about 100%; from about 25% to about 100%; from about 25% to about 100%; from about 30% to about 100%; from about 35% to about 100%; from about 40% to about 100%; from about 45% to about 100%; from about 50% to about 100%; from about 55% to about 100%; from about 60% to about 100%; from about 65% to about 100%; from 70% to about 100%; from about 75% to about 100%; from about 80% to about 100%; from about 85% to about 100%; from about 90% to about 100%; about 5%; about 10%; about 15%; about 20%; about 25%; about 30%; about 35%; about 40%; about 45%; about 50%; about 55%; about 60%; about 65%; about 70%; about 75%; about 80%; about 85%; about 90%; about 95%; or about 100%.

In an aspect of the present disclosure, the power output ranges between 50 W and 16 000 W. The power output is determined, at least in part, based on the volume to be treated. Smaller volumes require less power. In an embodiment of the present disclosure, the ultrasound-assisted extraction may be advantageously performed at an ultrasound power output ranging from about 50 W to about 150 W; from about 50 W to about 145 W; from about 55 W to about 140 W; from about 60 W to about 135 W; from about 65 W to about 130 W; from about 70 W to about 125 W; from about 70 W to about 120 W; about 78 W to about 116 W; about 50 W; about 55 W; about 60 W; about 65 W; about 75 W; about 80 W; about 85 W; about 90 W; about 94 W; about 95 W; about 100 W; about 102 W; about 105 W; about 110 W; about 115 W; or about 120 W.

In an embodiment of the present disclosure, the rare earth element-containing feed material is ground to a particle size ranging from about 3 mm to 60 microns; from about 2 mm to 60 microns; from about 1 mm to 60 microns; from about 0.5 mm to 60 microns; to a particle size less than 3 mm; to a particle size less than 2 mm; to a particle size less than 1 mm; to a particle size less than 0.5 mm; to a particle size less than 0.1 mm; to a particle size less than 0.05 mm; to a particle size less than 0.01 mm; to a particle size of about 100 microns; to a particle size of about 90 microns; to a particle size of about 80 microns; to a particle size of about 70 microns; or to a particle size of about 60 microns.

In an embodiment of the present disclosure, the rare earth element-containing feed material is a monazite feed material obtained from Vichada, Colombia. The feed material comprises a total rare earth content in excess of 61% (Table 12).

TABLE 12
Rare earth content of Vichada monazite feed material.

| | | Sample # | Sample # | Sample # | Sample # |
|---|---|---|---|---|---|
| Rare Earth | | (S00357795) | (S00357796) | (S00357793A) | (S00357795B) |
| Element | Symbol | Grade (%) | Grade (%) | Grade (%) | Grade (%) |
| Cerium | CeO₂ | 36.75 | 38.82 | 43.93 | 40.74 |
| Neodymium | Nd₂O₃ | 7.38 | 8.39 | 8.44 | 7.84 |
| Lanthanum | La₂O₃ | 9.37 | 6.80 | 7.77 | 8.56 |
| Praseodymium | Pr₆O₁₁ | 1.82 | 2.74 | 2.25 | 2.13 |
| Samarium | Sm₂O₃ | 2.08 | 2.59 | 2.37 | 2.12 |
| Gadolinium | Gd₂O₃ | 2.17 | 2.39 | 2.67 | 2.46 |
| Dysprosium | Dy₂O₃ | 0.70 | 0.96 | 0.49 | 0.91 |
| Yttrium | Y₂O₃ | 0.12 | 1.03 | 0.07 | 0.10 |
| Ytterbium | Yb₂O₃ | 0.38 | 0.40 | 0.22 | 0.61 |
| Erbium | Er₂O₃ | 0.25 | 0.09 | 0.11 | 0.20 |

| | | | | |
|---|---|---|---|---|
| Total Rare Earth | 61.02 | 64.21 | 68.32 | 65.67 |
| Oxide Content | | | | |

In addition to the rare earth values illustrated in Table 1, the Vichada monazite feed material may further comprise titanium (TiO₂), iron (Fe₂O₃), zirconium (ZrO₂), niobium (Nb₂O₅) and hafnium (HfO₂) values. Titanium readily combines with iron, aluminum, vanadium, nickel, molybdenum, and other metals to produce high-performance alloys useful for the manufacture of jet engines, spacecraft, and various military equipment. Titanium has been listed on the list of 35 minerals critical to U.S. national security.

While the present disclosure has been described with reference to specific examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

1. A process for extracting one or more rare earth elements from a rare earth element-containing material, the process comprising:
leaching the rare earth element-containing material in a caustic solution while sonicating the caustic solution, thereby producing a caustic pregnant solution and a first residue comprising rare earth hydroxides;
leaching the residue comprising rare earth hydroxides in a concentrated nitric acid solution while sonicating the nitric acid solution, thereby producing an acidic pregnant solution comprising rare earth nitrates and a second residue;
roasting the rare earth nitrates at a temperature ranging from about 280° C. to about 375° C. thereby producing a first roasted residue comprising at least one of rare earth oxides, rare earth oxynitrates and rare earth nitrates; and
roasting a residue substantially comprising rare earth nitrates at a temperature ranging from about 200° C. to about 250° C. thereby producing a second roasted residue.

2. The process of claim 1, further comprising evaporating the acidic pregnant solution thereby producing a residue comprising the rare earth nitrates.

3. The process of claim 1 or 2, further comprising leaching the first roasted residue in water thereby producing an aqueous pregnant solution comprising lanthanum and a lanthanum depleted residue.

4. The process of claim 3, further comprising leaching the lanthanum depleted residue in a weak nitric acid solution thereby producing an acidic pregnant solution substantially comprising the rare earth nitrates and a cerium comprising residue.

5. The process of claim 4, further comprising evaporating the acidic pregnant solution substantially comprising the rare earth nitrates, thereby providing the residue substantially comprising the rare earth nitrates.

6. The process of any one of claims 1 to 5, further comprising leaching the second roasted residue in water, thereby producing an aqueous pregnant solution enriched in nitrates of light rare earth elements (LREE) and a residue enriched in oxynitrates of heavy rare earth elements (HREE).

7. The process of claim 6, further comprising leaching the residue enriched in oxynitrates of heavy rare earth elements (HREE) in a nitric acid solution, thereby producing an acidic pregnant solution substantially comprising the nitrates of the heavy rare earth elements (HREE).

8. The process of claim 3, wherein the lanthanum comprises lanthanum nitrate (La (NO₃)₃).

9. The process of claim 4, wherein the cerium comprising residue is substantially cerium oxide (CeO₂).

10. The process of any one of claims 1 to 9, wherein sonicating the caustic solution and the nitric acid solution is performed at a frequency ranging from about 20 to about 200 kHz and an amplitude ranging from 1% to 100%.

11. The process of any one of claims 1 to 10, wherein the caustic leaching is performed at temperatures between 20° C. and 140° C.

12. The process of claim 1, wherein the nitric acid leaching is performed at a temperature between 20° C. and 90° C.

13. The process of any one of claims 1 to 12, further comprising at least one of converting the rare earth element containing material to a higher surface area material, or subjecting the rare earth element-containing material to at least one beneficiation step prior to the leaching to remove any gangue material.

14. The process of claim 13, wherein the at least one beneficiation step comprises separation based on optical and magnetic properties, sensor-based sorting, flotation, gravity separation, and comminuting, crushing or grinding.

15. The process of claim 6 or 7, wherein the light rare earth oxides comprise Y₂O₃ and Pr₆O₁₁.

16. The process of claim 6 or 7, wherein the heavy rare earth oxides comprise Yb₂O₃, Nd₂O₃, Sm₂O₃, Dy₂O₃, Gd₂O₃, and Er₂O₃.

17. The process of any one of claims 1 to 16, wherein the rare earth element-containing material comprises rare-earth element bearing ore materials, mine tailings, waste coal ash, or industrial waste materials.

18. The process of any one of claims 1 to 17, wherein the caustic solution comprises a caustic soda (NaOH) solution, a caustic KOH solution, or a caustic NH₄OH solution.

19. The process of any one of claims 1 to 17, wherein the caustic pregnant solution comprises dissolved sodium phosphate.

20. The process of any one of claims 1 to 19, wherein sonicating of the caustic solution is performed using an external sonication probe.

21. The process of any one of claims 1 to 20, wherein sonicating of the nitric acid solution is performed using an external sonication probe.

22. The process of claim 1, wherein the second residue comprises at least one of Si, Ta and Nb.

23. The process of any one of claims 1 to 22, wherein the rare earth element is at least one of scandium (Sc), yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), Erbium (Er), thulium (Tm), ytterbium (Yb), or lutetium (Lu).

24. The process of claim 23, wherein the rare earth element-containing material may further comprise a transition metal.

25. The process of claim 23 or 24, wherein the rare earth element-containing material may further comprise an actinide metal.

26. The process of any one of claims 1 to 25, wherein the rare earth element-containing material comprises a monazite ore material, bastnasite ore material, apatite ore material, or any combination thereof.

27. The process of any one of claims 1 to 26, further comprising subjecting the acidic pregnant solution to terbium precipitation step.

28. The process of claim 27, wherein the terbium precipitation step is performed using NH₄OH.

29. A process for extracting one or more rare earth elements from a rare earth element-containing material, the process comprising:
leaching the rare earth element-containing material in a caustic solution, thereby producing a caustic pregnant solution and a first residue comprising rare earth hydroxides;
leaching the residue comprising rare earth hydroxides in a concentrated nitric acid solution, thereby producing an acidic pregnant solution comprising rare earth nitrates and a second residue;
roasting the rare earth nitrates at a temperature ranging from about 280° C. to about 375° C. thereby producing a first roasted residue comprising at least one of rare earth oxides, rare earth oxynitrates and rare earth nitrates; and
roasting a residue substantially comprising the rare earth nitrates at a temperature ranging from about 200° C. to about 250° C. thereby producing a second roasted residue.

30. The process of claim 29, further comprising evaporating the acidic pregnant solution thereby producing a residue comprising the rare earth nitrates.

31. The process of claim 29 or 30, further comprising leaching the first roasted residue in water thereby producing an aqueous pregnant solution comprising lanthanum and a lanthanum depleted residue.

32. The process of claim 31, further comprising leaching the lanthanum depleted residue in a weak nitric acid solution thereby producing an acidic pregnant solution substantially comprising rare earth nitrates and a cerium comprising residue.

33. The process of claim 32, further comprising evaporating the acidic pregnant solution substantially comprising the earth nitrates, thereby providing the residue substantially comprising the rare earth nitrates.

34. The process of any one of claims 29 to 33, further comprising leaching the second roasted residue in water, thereby producing an aqueous pregnant solution enriched in nitrates of light rare earth elements (LREE) and a residue enriched in oxynitrates of heavy rare earth elements (HREE).

35. The process of claim 34, further comprising leaching the residue enriched in oxynitrates of heavy rare earth elements (HREE) in a nitric acid solution, thereby producing an acidic pregnant solution substantially comprising the nitrates of the heavy rare earth elements (HREE).

36. The process of claim 31, wherein the lanthanum comprises lanthanum nitrate (La (NO₃)₃).

37. The process of claim 32, wherein the cerium comprising residue is substantially cerium oxide (CeO₂).

38. The process of any one of claims 29 to 37, wherein sonicating the caustic solution and the nitric acid solution is performed at a frequency ranging from about 20 to about 200 kHz and an amplitude ranging from 1% to 100%.

39. The process of any one of claims 29 to 38, wherein the caustic leaching is performed at temperatures between 20° C. and 140° C.

40. The process of claim 29, wherein the nitric acid leaching is performed at a temperature between 20° C. and 90° C.

41. The process of any one of claims 29 to 40, further comprising at least one of converting the rare earth element containing material to a higher surface area material, or subjecting the rare earth element-containing material to at least one beneficiation step prior to the leaching to remove any gangue material.

42. The process of claim 41, wherein the at least one beneficiation step comprises separation based on optical and magnetic properties, sensor-based sorting, flotation, gravity separation, and comminuting, crushing or grinding.

43. The process of claim 34 or 35, wherein the light rare earth oxides comprise Y₂O₃ and Pr₆O₁₁.

44. The process of claim 34 or 35, wherein the heavy rare earth oxides comprise Yb₂O₃, Nd₂O₃, Sm₂O₃, Dy₂O₃, Gd₂O₃, and Er₂O₃.

45. The process of any one of claims 29 to 44, wherein the rare earth element-containing material comprises rare-earth element bearing ore materials, mine tailings, waste coal ash, or industrial waste materials.

46. The process of any one of claims 29 to 45, wherein the caustic solution comprises a caustic soda (NaOH) solution a caustic KOH solution or a caustic NH₄OH solution.

47. The process of any one of claims 29 to 45, wherein the caustic pregnant solution comprises dissolved sodium phosphate.

48. The process of claim 29, wherein the second residue comprises at least one of Si, Ta and Nb.

49. The process of any one of claims 29 to 48, wherein the rare earth element is at least one of scandium (Sc), yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), Erbium (Er), thulium (Tm), ytterbium (Yb), or lutetium (Lu).

50. The process of claim 49, wherein the rare earth element-containing material may further comprise a transition metal.

51. The process of claim 49 or 50, wherein the rare earth element-containing material may further comprise an actinide metal.

52. The process of any one of claims 29 to 51, wherein the rare earth element-containing material comprises a monazite ore material, bastnasite ore material, apatite ore material, or any combination thereof.

53. The process of any one of claims 29 to 52, further comprising subjecting the acidic pregnant solution to terbium precipitation step.

54. The process of claim 53, wherein the terbium precipitation step is performed using NH₄OH.
